(19) United States
(12) Patent Application Publication
(10) Pub. No.: US 2021/0209634 A1
(43) Pub. Date: Jul. 8, 2021

(54) NETWORK BASED VALUE ADDED TOKENS FOR RETAIL TRANSACTIONS

(71) Applicant: Catalina Marketing Corporation, St. Petersburg, FL (US)

(72) Inventor: Wassim Samir CHAAR, Coppell, TX (US)

(21) Appl. No.: 17/058,615

(22) PCT Filed: Aug. 8, 2018
(86) PCT No.: PCT/US2018/045857

§ 371 Date: Nov. 24, 2020

Related U.S. Application Data
(60) Provisional application No. 62/677,559, filed on May 29, 2018.

(51) Int. Cl. G06Q 30/02; G06Q 20/34; G06Q 20/36; G06Q 20/38

(52) U.S. Cl. CPC G06Q 30/0233; G06Q 30/0215; G06Q 20/381; G06Q 20/3672; G06Q 20/349

(57) ABSTRACT

A method, including receiving, from a consumer, a client device identification through an application installed in a client device, is provided. The method includes matching the client device identification with a loyalty card for a first retail store, identifying a shopping history associated with the first retail store, for the consumer, in a database, based on the loyalty card, and requesting an information about the consumer, through the application, based on the shopping history. The method also includes verifying an identity of the consumer when at least a portion of the information matches the shopping history associated with the first retail store, for the consumer, and increasing a token value in the loyalty card based on the identity of the consumer and the shopping history, wherein the consumer may redeem the token value at the first retail store or at a second retail store associated with the loyalty card.

### CROSS-REFERENCE TO RELATED APPLICATIONS

The present disclosure is related to, and claims priority under the rules and regulations of the PCT, to U.S. Provisional Patent Application No. 62/677,559, entitled “NETWORK BASED VALUE ADDED TOKENS FOR RETAIL TRANSACTIONS,” to Wassim Samir Chaar, filed on May 29, 2018, the contents of which are herein incorporated by reference in their entirety, for all purposes.

### BACKGROUND

### Field

The present disclosure generally relates to network based advertising campaigns and promotions. More specifically, the present disclosure is related to providing consumers value added tokens based on retail transactions via a networking device.

### Description of the Related Art

Retail vendors aggressively compete for market share among a customer sector that becomes more and more sophisticated with the advent of mobile computing devices and social network environments. To efficiently and reliably attract a customer base, retail vendors in brick-and-mortar stores are confronted with the task of competing with network based, online retail services. However, many of the marketing tools available today for retail vendors provide limited offers and perks for consumers, who systematically find it more attractive to complete transactions online.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a system configured to provide network based, value added tokens for retail transactions through a remote server, according to some embodiments.

FIG. 2 illustrates an example architecture suitable for implementing the system in FIG. 1, according to some embodiments.

FIG. 3A illustrates a system for handling value added tokens across multiple retail stores, service providers, and product lines, according to some embodiments.

FIG. 3B illustrates an exchange system for handling value added tokens for multiple retail stores, service providers, and product lines, using a universal value added token, according to some embodiments.

FIG. 4 is a flow chart illustrating steps in a method for adding a token value for a consumer, based on a shopping history with a retail store, according to some embodiments.

FIG. 5 is a flow chart illustrating steps in a method for using a token value by a consumer, according to some embodiments.

FIG. 6 is a block diagram illustrating an example computer system with which the client and network device of FIG. 1 and the methods of FIGS. 3-5 can be implemented.

In the figures, elements and steps denoted by the same or similar reference numerals are associated with the same or similar elements and steps, unless indicated otherwise.

### SUMMARY

In a first embodiment, a computer-implemented method is disclosed that includes receiving, from a consumer, a client device identification through an application installed in a client device. The computer-implemented method includes matching the client device identification with a loyalty card for a first retail store, identifying a shopping history associated with the first retail store, for the consumer, in a database, based on the loyalty card, and requesting an information about the consumer, through the application, based on the shopping history. The computer-implemented method also includes verifying an identity of the consumer when at least a portion of the information matches the shopping history associated with the first retail store, for the consumer, and increasing a token value in the loyalty card based on the identity of the consumer and the shopping history, wherein the consumer may redeem the token value at the first retail store or at a second retail store associated with the loyalty card.

In a second embodiment, a system is disclosed that includes a memory storing instructions, and one or more processors configured to execute the instructions to receive, from a consumer, a client device identification through an application installed in a client device. The one or more processors also execute instructions to match the client device identification with a loyalty card for a first retail store, to identify a shopping history associated with the first retail store, for the consumer, in a database, based on the loyalty card, and to request, through the application, an information about the consumer based on the shopping history. The one or more processors also execute instructions to verify an identity of the consumer when at least a portion of the information matches the shopping history associated with the first retail store, for the consumer, and to increase a token value in the loyalty card based on the identity of the consumer and the shopping history, wherein the consumer may redeem the token value at the first retail store or at a second retail store associated with the loyalty card.

In a third embodiment, a computer-implemented method is disclosed that includes transmitting, to a server, a client device identification through an application installed in a client device and hosted by the server. The client device identification is associated with a loyalty card provided by the server to a consumer using the client device. The computer-implemented method also includes providing, to the server, a shopping information through the application upon purchasing a consumer product at a first retail store, verifying a token value in the loyalty card through the application, and redeeming the token value at a second retail store associated with the loyalty card.

In yet other embodiment, a system is disclosed that includes a means for storing instructions, and a means for executing the instructions to cause the system to receive, from a consumer, a client device identification through an application installed in a client device. The means for executing instructions also cause the system to match the client device identification with a loyalty card for a first retail store, to identify a shopping history associated with the first retail store, for the consumer, in a database, based on the loyalty card, and to request, through the application, an information from the consumer based on the shopping history. The means for executing instructions also cause the system to verify an identity of the consumer when at least a portion of the information matches the shopping history associated with the first retail store, for the consumer, and to increase a token value in the loyalty card based on the identity of the consumer and the shopping history, wherein the consumer may redeem the token value at the first retail store or at a second retail store associated with the loyalty card.

### DETAILED DESCRIPTION

In the following detailed description, numerous specific details are set forth to provide a full understanding of the present disclosure. It will be apparent, however, to one ordinarily skilled in the art that embodiments of the present disclosure may be practiced without some of these specific details. In other instances, well-known structures and techniques have not been shown in detail so as not to obscure the disclosure.

### General Overview

Retailer-specific loyalty solutions to attract consumers typically fail to create meaningful consumer value beyond the confines of a specific retail store. In the face of a strong tide in online-commerce with aggressive network merchants that are encroaching retailers in every class of trade, it is highly desirable to offer more flexible loyalty solutions.

For example, it is desirable to provide consumer options beyond retailer trade promotions and to deliver meaningful value to shoppers within a broader consumer offering. It is also desirable to expand the definition of retailer loyalty, allowing for aggregated earnings and redemption across daily spend categories and specialty retail within a single application, and to augment and enhance current loyalty programs that consumers may have with specific retailers by offering incremental brand funded consumer value. Such strategies may increase consumer participation by further including cross-category merchants and service providers.

Some retailers have formed coalition loyalty efforts that have fell short of expectations in US markets and abroad. This indicates that coalitions and other ad-hoc groupings of retailers tend to converge to a limit in the market share, one way or another.

The disclosed system addresses this problem specifically arising in the realm of computer technology by providing a solution also rooted in computer technology, namely, by providing a system of universally accepted “tokens” or coins, provided and accounted electronically by a server based on a consumer purchasing history with one or more retailers. The tokens are accrued by consumers and the system guarantees the ability for the consumer to use the tokens as coins, in the purchase of other items from the original retail store, a second retail store, or even an online vendor (e.g., a travel agency, an insurance provider, and the like).

The subject system provides several advantages including the ability to use the accrued tokens at any time, and in at least a second retail store, or online vendor. In some embodiments the system provides a global, multi-category, cross retailer coalition loyalty platform. To achieve this, in some embodiments, the system provides a consumer facing, mobile first universal loyalty application, where consumer value “currency” is earned and redeemed at a grocery store, a convenience store, a drug store, an airline, and any other specialty retail store. Some embodiments include a centralized server that operates as the exchange for the tokens (e.g., as universal currency), aggregating and transferring consumer value between participating merchants and retailers.

Embodiments as disclosed herein provide an enhanced and more comprehensive view of consumer behavior across categories, enabling improved targeting and relevance of commercials, offers, and promotions to consumers. Further, embodiments as disclosed herein enable a service provider to extend a business model beyond instore and digital media delivery into a direct contact with consumers. Embodiments as disclosed herein provide a potential for a global business leverage to extend new co brand into an existing business model to create an instore and digital network for a service provider. Embodiments as disclosed herein use retailer store data and integrate point-of-sale (POS) hardware to the token system.

Although many examples provided herein describe a user's down-streaming activity being identifiable, each user may grant explicit permission for such user information to be shared or stored. The explicit permission may be granted using privacy controls integrated into the disclosed system. Each user may be provided notice that such user information will be shared with explicit consent, and each user may at any time terminate the information sharing, and may delete any stored user information. The stored user information may be encrypted to protect user security.

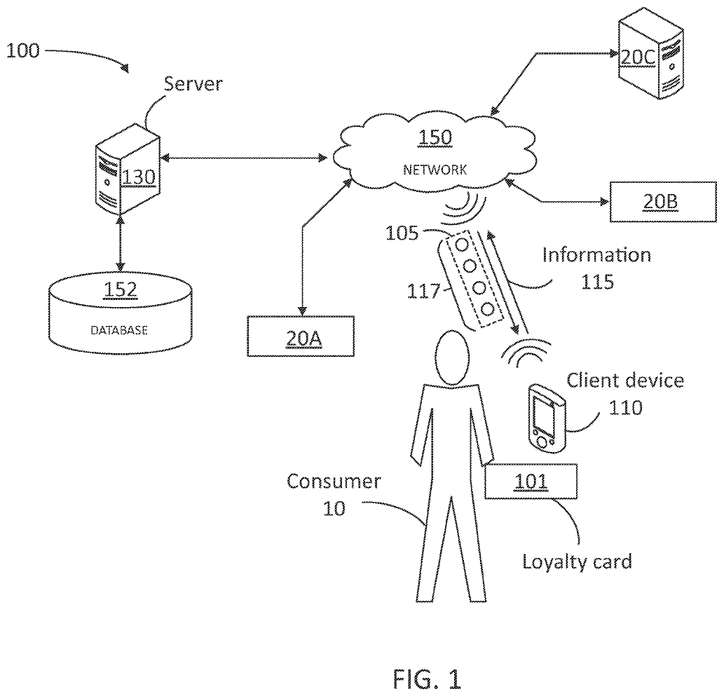

FIG. 1 illustrates a system 100 configured to provide network based, value added tokens 105 for retail transactions through a remote server 130, according to some embodiments. A consumer 10 may have a loyalty card 101 associated with server 130. Server 130 may be configured to provide consumer services for multiple retailers (e.g., supermarket 20A, supermarket 20B, vendor 20C, and others, hereinafter, collectively referred to as “vendors 20”). Vendors 20 may include brick and mortar stores (e.g., supermarket 20A and supermarket 20B) or may include online, server-based providers (e.g., internet stores and shopping networks, travel services, ticket masters, and the like, such as online vendor 20C, hosted by a network server).

Consumer 10 and retailers 20 may be registered with server 130, and may access the server through a network 150. A connection to network 150 is provided, in the case of consumer 10, by a client device 110. Client device 110 may include any type of mobile computer appliance that may wirelessly communicate with the server through the network. The server may handle a database 152 that includes service accounts, for the consumer and for any one of the retailers or online vendors. Accordingly, the server may also store in the database a consumer ID, including personal data such as a consumer history, the consumer identification being associated with a network identification of the client device (e.g., a cell phone number, when the client device is a smart phone). The consumer history in the server database may include a specific history of consumer purchases with each retailer or online vendor. In some embodiments, the consumer history with a retailer may be associated with an account for the retailer in the database, rather than with an account for the consumer. In some embodiments, the account for the consumer and the account for the retailer may be linked to each other in the database, e.g., through the consumer history.

The consumer provides information 115 to server 130 through network 150 (e.g., purchase history with any of vendors 20). For example, client device 110 may transmit a purchase information 115 to server 130, through network 150, as soon as a purchase is completed. Server 130 then verifies information 115 in database 152 and increases a token value 117 in loyalty card 101 of consumer 10, based on a promotion or advertising campaign. The promotion or advertising campaign may be sponsored by one of vendors 20, or by a service provider hosting server 130. In some embodiments, token value 117 (e.g., ‘four’ tokens, or coins) may be supported by funds provided by participating merchants (e.g., vendors 20).

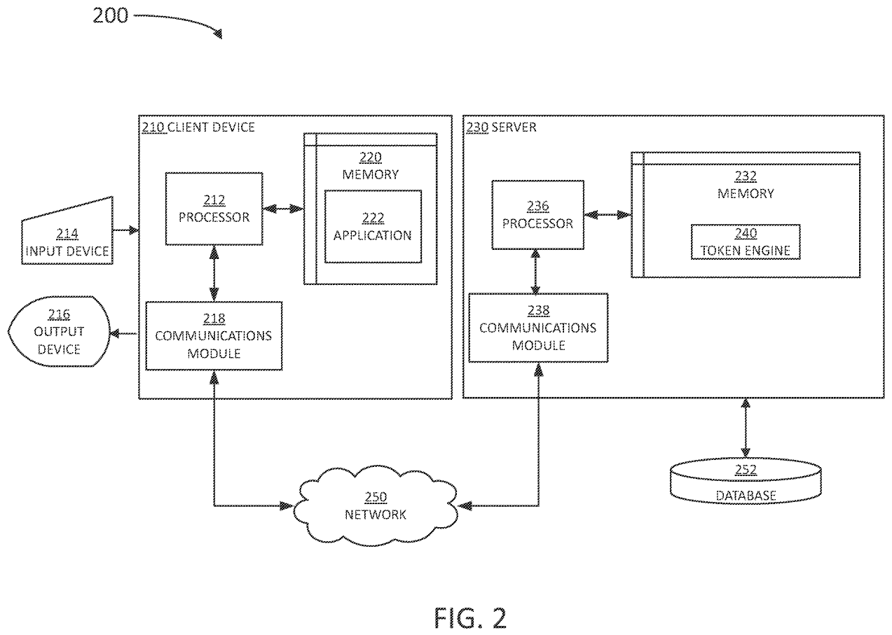

FIG. 2 illustrates an example architecture 200 for implementing the system in FIG. 1, according to some embodiments. Architecture 200 includes a server 230 and a client 210 connected over a network 250. In some embodiments, server 230 is configured to host a memory 232 including instructions which, when executed by a processor 236, cause the server 230 to perform at least some of the steps in methods as disclosed herein. In some embodiments, processor 236 is configured to receive consumer data, purchasing history, purchasing metadata (price history, consumer trends, and the like) from a user through client device 210. Client device 210 may include a processor 212 to execute commands stored in a memory 220. The commands in memory 220 may include an application 222 associated with services provided by server 230. Client device 210 and server 230 exchange data and other information through a communications module 218 in client 210, accessing a network 250, and a communications module 238 in server 230 accessing network 250. The user may be a consumer of any one of a brand or a retail store for consumer products registered as users of server 230. Further, in some embodiments, processor 236 in server 230 provides client 210 with a token value as a reward for the prior purchasing history of the consumer with a specific retailer, brand, or product.

Server 230 may include any device having an appropriate processor 236, a memory 232, and communications module 238 for performing marketing analysis. Client device 210 can be, for example, a desktop computer, a mobile computer, a tablet computer (e.g., including e-book readers), mobile devices (e.g., a smartphone or PDA), or any other devices having appropriate processor 212, memory 220, and communications module 218. Network 250 can include, for example, any one or more of a local area network (LAN), a wide area network (WAN), the Internet, and the like. Further, network 250 can include, but is not limited to, any one or more of the following network topologies, including a bus network, a star network, a ring network, a mesh network, a star-bus network, tree or hierarchical network, and the like.

Processor 236 is configured to increase or decrease a token value according to embodiments disclosed herein, executing commands stored in memory 232. In some embodiments, the commands include a token engine 240. More generally, token engine 240 may include any type of non-linear algorithm that uses marketing data such as consumer purchasing data from a retailer or a brand manufacturer, to estimate or determine a token value for a consumer. The marketing data may include a log or list of true shopping baskets purchased by one or an aggregated group of consumers over a period of time. Further, in some embodiments token engine 240 may include a linear regression algorithm used as a complement to a non-linear algorithm (e.g., a neural network, artificial intelligence, machine learning and the like), or a standalone algorithm for certain tasks or applications. In some embodiments, a purchasing history of the consumer is stored in a database 252. Database 252 may include a listing of consumer products classified according to a brand manufacturer, including a market history of each of the consumer products, for each brand. Database 252 may also include a list of consumers, shopping baskets and single products that have been purchased at a specific retailer store. Database 252 may include a list of multiple consumers across different retail stores, including purchasing history of each consumer for one or more retail stores, and one or more brands.

In some embodiments, database 252 may be included in memory 232. In some embodiments, at least a portion of brand database 252 may be external to server 230, but accessible to processor 236 through network 250 and communications module 238. In some embodiments, server 230 may be a datacenter accessible by brands, retail stores, etc. that may be registered to the service. Client device 210 may also be coupled with an input device 214 and an output device 216. Input device 214 may include a mouse, a keyboard, a touchscreen, and the like. Output device 216 may include a display, a touchscreen, a microphone, and the like. In some embodiments, input device 214 and output device 216 may be included in the same unit (e.g., a touchscreen).

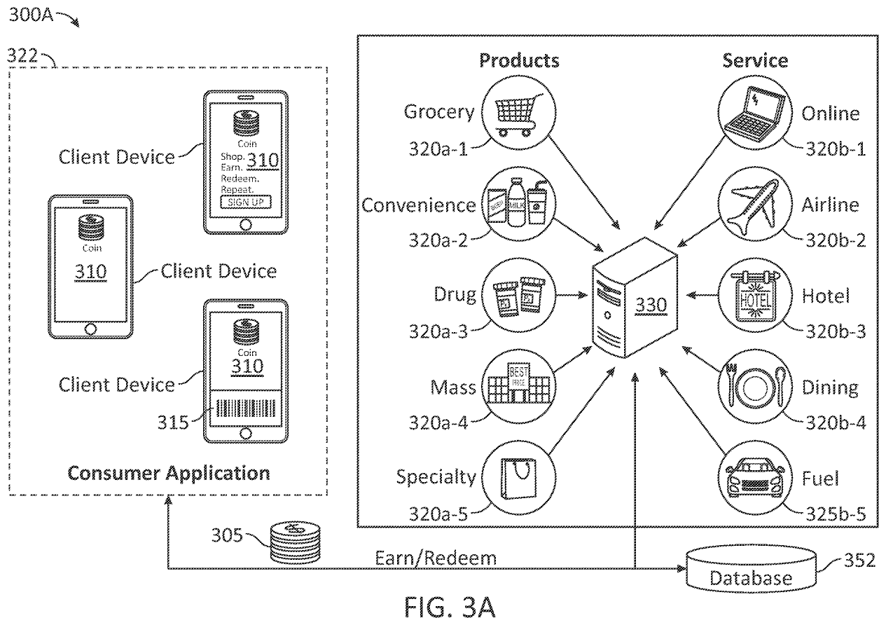

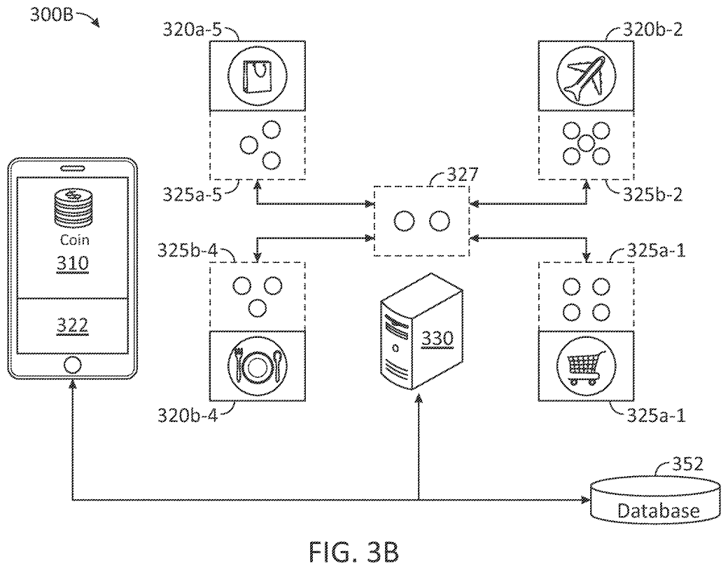

FIG. 3A illustrates a system 300A for handling value added tokens 305 (e.g., tokens 105) across multiple retail stores, service providers, and product lines, according to some embodiments. Server 330 may host a mobile application 322 installed in client device 310. Mobile application 322 may be configured to enable currency earning and redemption at a POS of a retail store (e.g., retail stores 20A or 20B), or at a server hosted by an online vendor (e.g., online vendor 20C). In some embodiments, mobile application 322 may include merchant and brand funded special offers that the consumer (e.g., consumer 10) is aware of. When the consumer purchases a selected item from a retailer or online vendor, the purchase data is collected in a database (e.g., databases 152 or 252), to increase personalization and targeting of relevant consumer offers. The selected item may include any one of multiple products 320a-1, 320a-2, 320a-3, 320a-4, and 320a-5 (hereinafter, collectively referred to as “products 320a”), or multiple services 320b-1, 320b-2, 320b-3, 320b-4, or 320b-5 (hereinafter, collectively referred to as “services 320b”). In some embodiments, mobile application 322 may include a consumer identifier 315 (e.g., a barcode or any other visual or radio-frequency identifier) that the consumer may scan at a retail store or any other scanning mechanism, so that the retail store may access a consumer information (e.g., purchasing history, accrued token value, and the like), in a database 352.

Consumers may earn/redeem tokens 305 through server 330 in the purchase of products 320a such as groceries from grocery store 320a-1 or convenience store 320a-2, drugs and medications from a pharmacy 320a-3, mass shopping 320a-4, or specialty shopping 320a-5. Further, consumers may earn/redeem tokens 305 through server 330 in service transactions 320b such as online shopping 320b-1, tickets from airline 320b-2, hotel reservations 320b-3, dining at restaurant 320b-4 and fuel purchasing at a gas station 320b-5. In some embodiments, the consumer may purchase coins directly at the server exchange, to use at a later time on any other transaction, when the consumer is short in cash (e.g., at a grocery store, or traveling).

Data collected in the database is used for enhanced targeting and personalization of marketing campaigns and offers including consumer rewards in the form of tokens 305 that can be redeemed (e.g., as universal currency) by the consumer at any of the participating retail stores or online vendors.

The determination of a token value for a given transaction by the consumer is performed in server 330 based on a consumer history, and other marketing considerations, such as retail value of a purchased item, and location of purchase. In some embodiments the token value is paired with a monetary value spent by the consumer on a selected item that is for sale, or offer for a value added token. In some embodiments, the token value may be a pre-selected factor of the retail value of a purchase. In yet other embodiments, the token value may be a variable factor of the retail value of the purchase, wherein the variable factor increases with the value of the purchase. In some embodiments, the token value may be proportional to a mileage traveled on an airplane ticket. In some embodiments, a token value may be increased based on other premises, such as specific information about the consumer (e.g., the consumer is a platinum consumer at the retailer, and the like).

In some embodiments, server 330 acts as an exchange center to aggregate and transfer consumer value between participating merchants using the universal value of the tokens. Further, in some embodiments, the currency value of tokens 305 is managed by server 330, thus allowing the consumer to earn and allocate value across all merchants, at will.

FIG. 3B illustrates an exchange system 300B for handling value added tokens 325a-1 for multiple retail stores 320a-1, tokens 325b-4 for service providers 320b-4, and tokens 325a-5 for product lines 320a-5 (hereinafter, collectively referred to as “retail tokens 325”), using a universal token 327, according to some embodiments. The exchange rate between retail tokens 325 and universal token 327 may be pre-selected between the retailer who owns retail token 325 and the host of server 330. For example, and without limitation, three retail tokens 325a-3 from pharmacy 320a-3, or 325b-4 from restaurant 320b-4 may be converted into two universal tokens 327; five retail tokens 325b-2 from airline 320b-2 may be converted into two universal tokens 327; and four retail tokens 325a-1 from grocery store 320a-1 may be converted into two universal tokens 327.

Accordingly, in some embodiments, a consumer having universal tokens 327 may use them in any one of retailer 320a-3, grocery store 320a-1, or airline 320b-2 to obtain items and services for the value corresponding to the exchange rate illustrated. The exchange rates illustrated between retail tokens 325 and universal tokens 327 may be stored in database 352 (e.g., database 252). The consumer may access exchange system 300B through application 322 in client device 310.

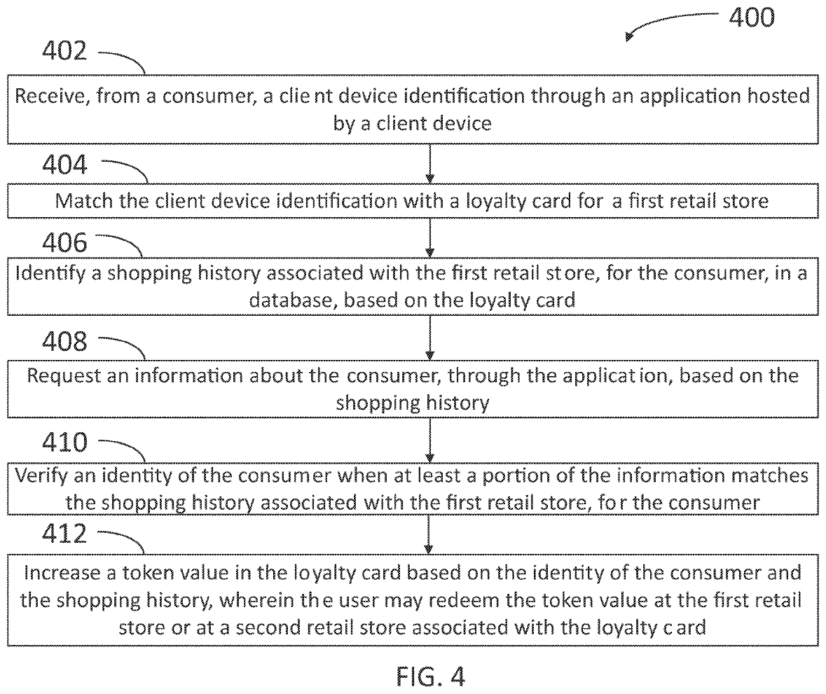

FIG. 4 illustrates steps in a method 400 for adding a token value for a consumer, based on a shopping history with a retailer store, according to some embodiments. Method 400 may be performed at least partially by any one of the servers and computers illustrated in FIGS. 1 and 2. For example, at least some of the steps in method 400 may be performed by one component in a system including a client device running code for a browser and an application to access a website hosted by a server that provides a token value (e.g., a universal currency). Accordingly, at least some of the steps in method 400 may be performed by a processor executing commands stored in a memory of the server or the client device, or accessible by the server or the client device. Further, in some embodiments, at least some of the steps in method 400 may be performed overlapping in time, almost simultaneously, or in a different order from the order illustrated in method 400. Moreover, a method consistent with some embodiments disclosed herein may include at least one, but not all, of the steps in method 400.

Step 402 includes receiving, from a consumer, a client device identification through an application hosted by a client device.

Step 404 includes matching the client device identification with a loyalty card for a first retail store. In some embodiments, step 404 includes verifying the client device identification when the consumer is purchasing an item through a network based application in the client device.

Step 406 includes identifying a shopping history associated with the first retail store, for the consumer, in a database, based on the loyalty card.

Step 408 includes requesting an information about the consumer, through the application, based on the shopping history. The information may include an item purchased at the first retail store, or the presence of the consumer at the first retail store.

Step 410 includes verifying an identity of the consumer when at least a portion of the information matches the shopping history associated with the first retail store, for the consumer.

Step 412 includes increasing a token value in the loyalty card based on the identity of the consumer and the shopping history, wherein the user may redeem the token value at the retail store or at a second retail store associated with the loyalty card. In some embodiments, step 412 includes verifying a qualification for a retail offer or an advertising campaign by the retail store. In some embodiments, step 412 includes instructing a point of sale at the first retail store or the second retail store to print a voucher for the consumer in an amount proportional to the token value. In some embodiments, at least one of the first retail store or the second retail store includes an online shopping service of the first retail store or the second retail store, and receiving the client device identification includes hosting an application for the online shopping service of the first retail store or the second retail store. In some embodiments, a second application hosted by an online service provider is installed in the client device, and step 412 further includes validating at least a portion of the token value against the online service provider in the second application. In some embodiments, step 412 further includes transferring a token value into a financial account when the token value meets or exceeds a predefined threshold. In some embodiments, step 412 further includes transmitting, to the consumer via the client device, an offer for a product in the first retail store, the offer associated to the token value in the loyalty card.

In some embodiments, step 412 includes converting a first token value into a second token value based on an exchange rate between the first retail store and the second retail store. In some embodiments, the first retail store includes a first consumer price in a first currency and the second retail store includes a second consumer price in a second currency, and step 412 includes converting the first currency and the second currency into the token value. In some embodiments, step 412 includes querying the consumer, via the client device, whether to convert the token value into a reward offered by a third party vendor, the third party vendor including at least one of the first retail store or the second retail store. In some embodiments, step 412 includes providing to the consumer, via a coupon application installed in the client device, an option to add the token value to an offer selected from the coupon application for a purchase at the first retail store or the second retail store. In some embodiments, step 412 includes transmitting a validation code to a server hosting a purchasing transaction for the first retail store or the second retail store. In some embodiments, step 412 includes transferring the token value from the loyalty card to a second loyalty card upon request by the consumer.

A computer-implemented method includes receiving, from a consumer, a client device identification through an application hosted by a client device, matching the client device identification with a loyalty card for a retail store, and identifying a shopping history associated with the retail store, for the consumer, in a database, based on the loyalty card. The computer-implemented method includes requesting an information from the consumer, through the application, based on the shopping history, verifying an identity of the consumer when at least a portion of the information matches the shopping history associated with the retail store, for the consumer, and increasing a token value in the loyalty card based on the identity of the consumer and the shopping history, wherein the consumer may redeem the token value at the retail store or at a second retail store associated with the loyalty card.

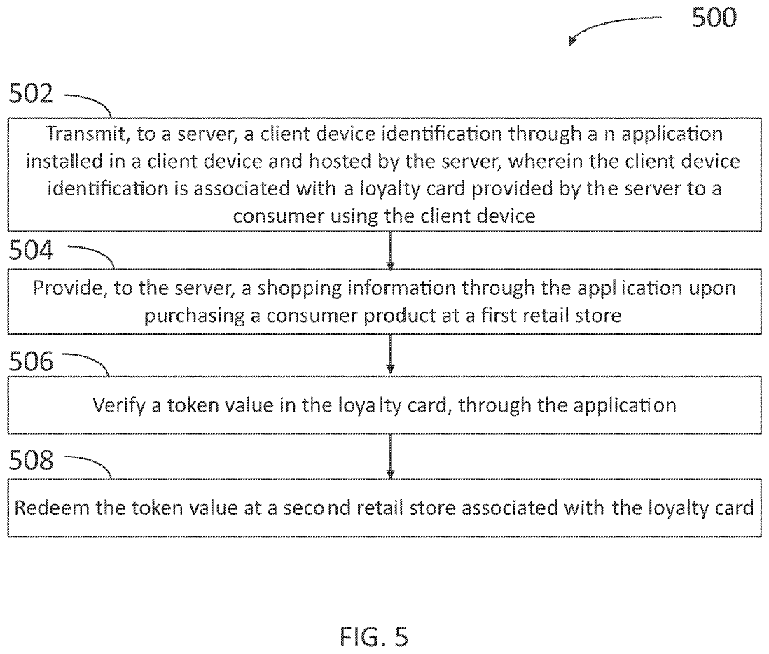

FIG. 5 is a flow chart illustrating steps in a method 500 for using a token value by a consumer, according to some embodiments. Method 500 may be performed at least partially by any one of the servers and computers illustrated in FIGS. 1 and 2. For example, at least some of the steps in method 500 may be performed by one component in a system including a client device running code for a browser and an application to access a website hosted by a server that provides a token value (e.g., a universal currency). Accordingly, at least some of the steps in method 500 may be performed by a processor executing commands stored in a memory of the server or the client device, or accessible by the server or the client device. Further, in some embodiments, at least some of the steps in method 500 may be performed overlapping in time, almost simultaneously, or in a different order from the order illustrated in method 500. Moreover, a method consistent with some embodiments disclosed herein may include at least one, but not all, of the steps in method 500.

Step 502 includes transmitting, to a server, a client device identification through an application installed in a client device and hosted by the server, wherein the client device identification is associated with a loyalty card provided by the server to a consumer using the client device. In some embodiments, at least one of the first retail store or the second retail store includes an online shopping service of the first retail store or the second retail store, and transmitting the client device identification includes running an application for the online shopping service of the first retail store or the second retail store.

Step 504 includes providing, to the server, a shopping information through the application upon purchasing a consumer product at a first retail store.

Step 506 includes verifying a token value in the loyalty card, through the application.

Step 508 includes redeeming the token value at a second retail store associated with the loyalty card. In some embodiments, step 508 includes selecting, via an application in the client device, an offer for a product in the first retail store, the offer associated to the token value in the loyalty card.

### Hardware Overview

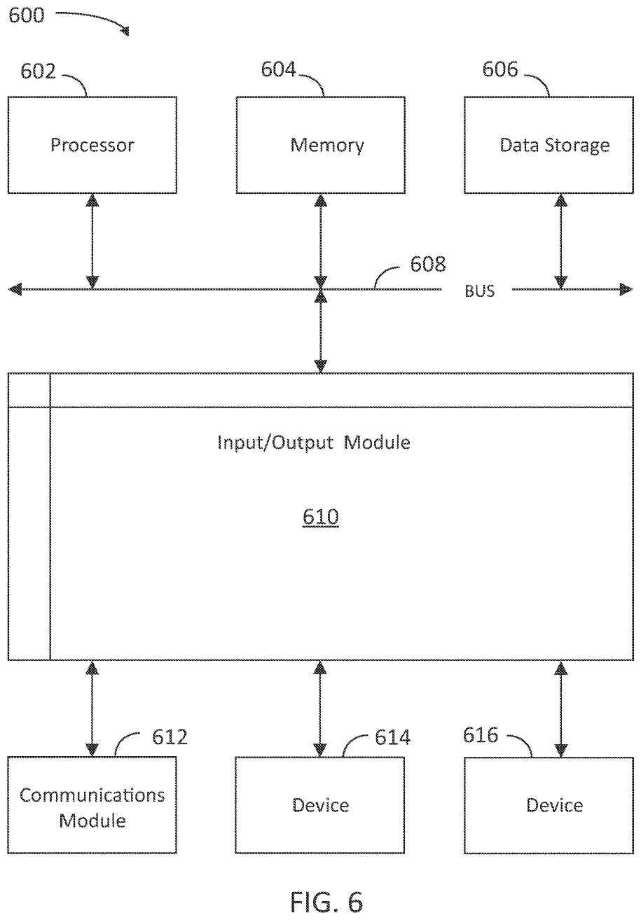

FIG. 6 is a block diagram illustrating an example computer system 600 with which the client and network device of FIG. 1 and the methods of FIGS. 4-5 can be implemented. In certain aspects, computer system 600 may be implemented using hardware or a combination of software and hardware, either in a dedicated network device, or integrated into another entity, or distributed across multiple entities.

Computer system 600 (e.g., client device 110 and network device 130) includes a bus 608 or other communication mechanism for communicating information, and a processor 602 (e.g., processors 212 and 236) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memories 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program consumer products, e.g., one or more modules of computer program instructions encoded on a computer readable medium for execution by, or to control the operation of, the computer system 600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. Input/output module 610 can be any input/output module. Exemplary input/output modules 610 include data ports such as USB ports. The input/output module 610 is configured to connect to a communications module 612. Exemplary communications modules 612 (e.g., communications modules 218 and 238) include networking interface cards, such as Ethernet cards and modems. In certain aspects, input/output module 610 is configured to connect to a plurality of devices, such as an input device 614 (e.g., input device 114) and/or an output device 616 (e.g., output device 116). Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 616 include display devices, such as an LCD (liquid crystal display) monitor, for displaying information to the user.

According to one aspect of the present disclosure, the client device 110 and network device 130 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data network device, or that includes a middleware component, e.g., an application network device, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and network devices. A client and network device are generally remote from each other and typically interact through a communication network. The relationship of client and network device arises by virtue of computer programs running on the respective computers and having a client-network device relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

Embodiments disclosed herein include:

A. A computer-implemented method that includes receiving, from a consumer, a client device identification through an application installed in a client device. The computer-implemented method includes matching the client device identification with a loyalty card for a first retail store, identifying a shopping history associated with the first retail store, for the consumer, in a database, based on the loyalty card, and requesting an information about the consumer, through the application, based on the shopping history. The computer-implemented method also includes verifying an identity of the consumer when at least a portion of the information matches the shopping history associated with the first retail store, for the consumer, and increasing a token value in the loyalty card based on the identity of the consumer and the shopping history, wherein the consumer may redeem the token value at the first retail store or at a second retail store associated with the loyalty card.

B. A system that includes a memory storing instructions, and one or more processors configured to execute the instructions to receive, from a consumer, a client device identification through an application installed in a client device. The one or more processors also execute instructions to match the client device identification with a loyalty card for a first retail store, to identify a shopping history associated with the first retail store, for the consumer, in a database, based on the loyalty card, and to request, through the application, an information about the consumer based on the shopping history. The one or more processors also execute instructions to verify an identity of the consumer when at least a portion of the information matches the shopping history associated with the first retail store, for the consumer, and to increase a token value in the loyalty card based on the identity of the consumer and the shopping history, wherein the consumer may redeem the token value at the first retail store or at a second retail store associated with the loyalty card.

C. A computer-implemented method that includes transmitting, to a server, a client device identification through an application installed in a client device and hosted by the server. The client device identification is associated with a loyalty card provided by the server to a consumer using the client device. The computer-implemented method also includes providing, to the server, a shopping information through the application upon purchasing a consumer product at a first retail store, verifying a token value in the loyalty card through the application, and redeeming the token value at a second retail store associated with the loyalty card.

Each of embodiments A, B, and C may have one or more of the following additional elements in any combination, as follows. Element 1, wherein at least one of the first retail store or the second retail store includes an online shopping service of the first retail store or the second retail store, and receiving the client device identification includes hosting an application for the online shopping service of the first retail store or the second retail store. Element 2, wherein a second application hosted by an online service provider is installed in the client device, further including validating at least a portion of the token value against the online service provider in the second application. Element 3, further including transferring a token value into a financial account when the token value meets or exceeds a predefined threshold. Element 4, further including transmitting, to the consumer via the client device, an offer for a product in the first retail store, the offer associated to the token value in the loyalty card. Element 5, wherein increasing the token value includes converting a first token value into a second token value based on an exchange rate between the first retail store and the second retail store. Element 6, further including querying the consumer, via the client device, whether to convert the token value into a reward offered by a third party vendor, the third party vendor including at least one of the first retail store or the second retail store. Element 7, further including providing to the consumer, via a coupon application installed in the client device, an option to add the token value to an offer selected from the coupon application for a purchase at the first retail store or the second retail store. Element 8, wherein increasing a token value in the loyalty card further includes transmitting a validation code to a server hosting a purchasing transaction for the first retail store or the second retail store. Element 9, further including transferring the token value from the loyalty card to a second loyalty card upon request by the consumer.

Element 10, wherein at least one of the first retail store or the second retail store includes an online shopping service of the first retail store or the second retail store, and transmitting the client device identification includes running an application for the online shopping service of the first retail store or the second retail store. Element 11, further including selecting, via an application in the client device, an offer for a product in the first retail store, the offer associated to the token value in the loyalty card.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of X, Y, and Z” or “at least one of X, Y, or Z” each refer to only X, only Y, or only Z; any combination of X, Y, and Z; and/or at least one of each of X, Y, and Z.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software consumer products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A computer-implemented method, comprising:
receiving, from a consumer, a client device identification through an application installed in a client device;
matching the client device identification with a loyalty card for a first retail store;
identifying a shopping history associated with the first retail store, for the consumer, in a database, based on the loyalty card;
requesting an information from the consumer, through the application, based on the shopping history;
verifying an identity of the consumer when at least a portion of the information matches the shopping history associated with the first retail store, for the consumer; and
increasing a token value in the loyalty card based on the identity of the consumer and the shopping history, wherein the consumer may redeem the token value at the first retail store or at a second retail store associated with the loyalty card.

2. The computer-implemented method of claim 1, wherein at least one of the first retail store or the second retail store comprises an online shopping service of the first retail store or the second retail store, and receiving the client device identification comprises hosting an application for the online shopping service of the first retail store or the second retail store.

3. The computer-implemented method of claim 1, wherein a second application hosted by an online service provider is installed in the client device, further comprising validating at least a portion of the token value against the online service provider in the second application.

4. The computer-implemented method of claim 1, further comprising transferring a token value into a financial account when the token value meets or exceeds a predefined threshold.

5. The computer-implemented method of claim 1, further comprising transmitting, to the consumer via the client device, an offer for a product in the first retail store, the offer associated to the token value in the loyalty card.

6. The computer-implemented method of claim 1, wherein the first retail store includes a first consumer price in a first currency and the second retail store includes a second consumer price in a second currency, and increasing the token value comprises converting the first currency and the second currency into the token value.

7. The computer-implemented method of claim 1, further comprising querying the consumer, via the client device, whether to convert the token value into a reward offered by a third party vendor, the third party vendor comprising at least one of the first retail store or the second retail store.

8. The computer-implemented method of claim 1, further comprising providing to the consumer, via a coupon application installed in the client device, an option to add the token value to an offer selected from the coupon application for a purchase at the first retail store or the second retail store.

9. The computer-implemented method of claim 1, wherein increasing a token value in the loyalty card further comprises transmitting a validation code to a server hosting a purchasing transaction for the first retail store or the second retail store.

10. The computer-implemented method of claim 1, further comprising transferring the token value from the loyalty card to a second loyalty card upon request by the consumer.

11. A system, comprising:
a memory circuit storing instructions; and
one or more processors configured to execute the instructions to cause the system to:
receive, from a consumer, a client device identification through an application installed in a client device;
match the client device identification with a loyalty card for a first retail store;
identify a shopping history associated with the first retail store, for the consumer, in a database, based on the loyalty card;
request, through the application, an information from the consumer based on the shopping history;
verify an identity of the consumer when at least a portion of the information matches the shopping history associated with the first retail store, for the consumer; and
increase a token value in the loyalty card based on the identity of the consumer and the shopping history, wherein the consumer may redeem the token value at the first retail store or at a second retail store associated with the loyalty card.

12. The system of claim 11, wherein at least one of the first retail store or the second retail store comprises an online shopping service of the first retail store or the second retail store, and to receive the client device identification, the one or more processors execute instructions to host an application for the online shopping service of the first retail store or the second retail store.

13. The system of claim 11, wherein the application installed in the client device is hosted by an online service provider, and wherein the one or more processors further execute instructions to validate at least a portion of the token value against a service provider for the consumer.

14. The system of claim 11, wherein the one or more processors further execute instructions to transfer a token value into a financial account when the token value meets or exceeds a predefined threshold.

15. The system of claim 11, wherein the one or more processors further execute instructions to transmit, to the consumer via the client device, an offer for a product in the first retail store, the offer associated to the token value in the loyalty card.

16. The system of claim 11, wherein the first retail store includes a first consumer price in a first currency and the second retail store includes a second consumer price in a second currency, and to increase the token value the one or more processors execute instructions to convert the first currency and the second currency into the token value.

17. The system of claim 11, wherein the one or more processors further execute instructions to query the consumer, via the client device, whether to convert the token value into a reward offered by a third party vendor, the third party vendor comprising at least one of the first retail store or the second retail store.

18. A computer-implemented method, comprising:
transmitting, to a server, a client device identification through an application installed in a client device and hosted by the server, wherein the client device identification is associated with a loyalty card provided by the server to a consumer using the client device;
providing, to the server, a shopping information through the application upon purchasing a consumer product at a first retail store;
verifying a token value in the loyalty card through the application; and
redeeming the token value at a second retail store associated with the loyalty card.

19. The computer-implemented method of claim 18, wherein at least one of the first retail store or the second retail store comprises an online shopping service of the first retail store or the second retail store, and transmitting the client device identification comprises running an application for the online shopping service of the first retail store or the second retail store.

20. The computer-implemented method of claim 18, further comprising selecting, via an application in the client device, an offer for a product in the first retail store, the offer associated to the token value in the loyalty card.
